(19) United States
(12) Patent Application Publication
(10) Pub. No.: US 2026/0258203 A1
(43) Pub. Date: Sep. 3, 2026

(54) PROCESS FOR CONVERSION OF LIGNOCELLULOSIC MATERIAL TO AN ORGANIC LIQUEFACTION PRODUCT

(71) Applicant: RISE RESEARCH INSTITUTES OF SWEDEN AB, Borås (SE)

(72) Inventors: Karen Abreu Resende, Porvoo (FI); Noora Kaisalo, Porvoo (FI); Pekka Nurmi, Porvoo (FI); Marja Tiitta, Porvoo (FI); Martin Hedberg, Södertälje (SE); Christian Bernlind, Södertälje (SE)

(21) Appl. No.: 18/846,715

(22) PCT Filed: Mar. 17, 2023
(86) PCT No.: PCT/EP2023/056910

§ 371 Date: Sep. 13, 2024

(30) Foreign Application Priority Data
Mar. 17, 2022 (SE) 2250332-0

(51) Int. Cl. C08H 8/00; B01J 27/051; B01J 37/04; B01J 37/08; B01J 37/20

(52) U.S. Cl. CPC C08H 8/00; B01J 27/0515; B01J 37/04; B01J 37/08; B01J 37/20

(57) ABSTRACT

Lignocellulosic starting materials can be converted into one or more liquid phases and/or an aqueous phase and a hydrocarbon phase in a process by subjecting a mixture of a lignocellulosic starting material, an amorphous and unsupported sulfided molybdenum catalyst comprising one or more of the following elements; iron (Fe), tungsten (W), cobalt (Co), vanadium (V) and ruthenium (Ru), and a co-feed, to not less than a stoichiometric amount of hydrogen, elevated pressure and a temperature within the range of from 270 to 450° C. A catalyst for use in said process and a method for its production are also disclosed.

### TECHNICAL FIELD

The present disclosure relates to a novel process to convert solid lignocellulosic raw materials to an organic liquefaction product, a novel sulfided molybdenum catalyst for use in said process, and methods for the production of said catalyst.

### BACKGROUND

It is well known that thermochemical methods like pyrolysis and hydrothermal liquefaction (HTL) can depolymerize whole lignocellulosic biomass as well as lignocellulosic biomass fractionation products like kraft lignin and other renewable side streams from agriculture, forestry and the paper and pulping industry, often producing liquefied products collectively referred to as “bio-oils” or “bio-crude”. These can then be upgraded further using hydrotreatment and hydrocracking technologies more or less similar to the ones used to upgrade fossil crude oil and its distillates in oil refineries, to obtain mixtures of hydrocarbons which can be used as for instance transport fuel components.

Problems frequently encountered in thermochemical liquefaction (pyrolysis or HTL) of biomass include for example a relatively high oxygen content and a spontaneously reactive nature of the resulting depolymerized product mixture, containing among other different structural classes of molecules, reactive phenol derivatives in combination with aldehydes and ketones, which together cause more or less severe repolymerization during storage and/or heating. Other issues are for example the formation of char and a loss of high-volatility organic components, resulting in eventually lower carbon yields of hydrocarbon fuel components after upgrading than desirable.

One example of further issues is a high content of water in the resulting products. In addition, this water is often very difficult or impossible to remove by phase separation due to the polar nature of many of the organic components in the bio-oils. Distillation to remove water is precluded by the lack of stability during heating due to the repolymerization issue mentioned above. Further, the high content of water, in combination with the acidic nature of bio-oils, creates a situation where the bio-oils are highly corrosive to standard construction materials used in refinery upgrading equipment. To illustrate with figures, pyrolytic degradation of lignocellulosic materials results in an oxygen content in the condensable fractions in the range of 20->40%. The same condensable fractions usually have pH-values of around 2-3 as a result of a high content of carboxylic acids and water. Overall, this means that the total oxygen and water content are not significantly lower than in the more stable non-depolymerized, dried but otherwise non-treated and considerably less acidic lignocellulosic biomass.

Summarizing the above, pyrolysis or HTL consequently, although the goal of obtaining a pumpable liquid bio-oil is often achieved, yield bio-oil or biocrude products which are both corrosive and unstable for storage and heating due to issues with spontaneous repolymerization. Additionally, these products display poor or no miscibility with fossil or other renewable feedstocks of interest for facile and flexible co-processing in current standard refinery infrastructure. These properties are obviously problematic when developing practical robust full-scale processes for upgrading of pyrolysis and/or HTL bio-oils both individually and through co-processing to hydrocarbon transport fuels and chemicals.

Concerning hydrocracking catalysts which can be used to upgrade fully and/or partly renewable feedstocks and feedstock mixtures, there are a large number of different base metal and noble metal catalysts published in the literature, which have been used to more or less successfully upgrade bio-oils or other materials derived from lignocellulose to hydrocarbon-rich product mixtures. These catalysts can either be based on single metals or consist of combinations of different metals or metal compounds which are either supported on chemically inert or reactive support materials or not.

In summary, there is a demand for improved simple and robust processes, which can be applied to lignocellulosic raw materials and which are amenable for upscaling. These and other objectives will be apparent from the summary and the descriptions of certain embodiments below. It will be understood by those skilled in the art that one or more aspects can meet certain objectives, while one or more other aspects can meet certain other objectives.

### SUMMARY

The present disclosure makes available a new hydroliquefaction process and a new catalyst for use in said process, as well as a method for manufacture of said catalyst. According to a first aspect, this process for the conversion of lignocellulosic starting materials into an organic liquefaction product is characterized in that a lignocellulosic starting material, optionally either from a single source or from a mixture of relevant starting materials, an amorphous and unsupported sulfided molybdenum catalyst comprising one or more of the following elements; iron (Fe), tungsten (W), cobalt (Co), vanadium (V) and ruthenium (Ru), and a co-feed, are mixed and subjected to not less than a stoichiometric amount of hydrogen, elevated pressure and a temperature within the range of 270-450° C., thereby producing an organic liquefaction product.

The process according to the present disclosure is a hydroliquefaction process, converting lignocellulosic biomass from solid phase to an organic liquefaction product, which organic liquefaction product may for example be subsequently converted into fuels, or used in the production of chemicals. An advantage of the process according to the present disclosure is that it may be carried out at surprisingly low temperatures, and thus has advantages in terms of decreased energy consumption in turn resulting in potential cost benefits.

A further advantage is that the organic liquefaction product, which may be an intermediate product intended for further conversion into one or more final products, has a low oxygen content which makes it a more thermally stable intermediate product and stable for storage.

In prior art of lignocellulose hydroliquefaction, typical carrier oil has been hydrogen donor solvent such as tetralin.

Compared to prior art using of CoMo catalyst to liquefy biomass (reference is made to Burton et al 1986, “Catalytic Hydroliquefaction of Lignocellulosic Biomass”, International Journal of Solar Energy), the process of the current invention does not require usage of a hydrogen donor solvent, such as tetralin, as co-feed, but the co-feed can be for example paraffinic. A further advantage of the current process, compared to prior art, is that the process works with high solid lignocellulose contents. A still further advantage is that the organic liquefaction product has better quality compared to for the example to the product by Burton et al., who obtained a significant amount of asphaltenes from the process.

The co-feed may thus comprise a co-feed other than tetralin.

The co-feed may optionally be substantially free from tetralin, i.e. such that at least 99% of the co-feed is free from tetralin, or that at least 99.5% is free from tetralin. When the co-feed is substantially free from tetralin this means that no tetralin has been added as co-feed during the process, but a minor residue of tetralin may be formed during the process. Optionally, the co-feed is free from tetralin. The fact that the process may be carried out with a co-feed being substantially free from, or free from, tetralin enables the use of less expensive, conventional and readily accessible refinery feedstock or the use of recycled product or fraction of the product and thus provides a flexibility to the co-feed selection as co-feed is not required to have strong hydrogen donating capabilities to obtain high conversion of solid lignocellulosic starting material.

The liquid phase additionally demonstrates improved physical properties, giving process benefits upon subsequent process steps, such as during pumping. Furthermore, the intermediate liquid product obtained may, due to its low oxygen content, also be more easily integrated as raw materials in conventional refineries.

A further advantage is that the low oxygen content in the organic liquefaction product obtained by the process according to the present disclosure enables lower exotherms during complete hydrodeoxygenation to form hydrocarbon end products.

The term “elevated pressure” refers to a pressure which is above atmospheric pressure.

The molar fraction of sulfur (S) in said amorphous and unsupported sulfided molybdenum catalyst with respect to the content of molybdenum (Mo) may be within the range of from 0.1 to 2.3. The catalyst as disclosed herein has, surprisingly been found by the present inventors, to enable liquefaction of lignocellulosic starting material with high yield.

The molar fraction of sulfur (S) in the amorphous and unsupported sulfided molybdenum catalyst with respect to the molar fraction of molybdenum (Mo) may be within the range of from 0.1 to 1.0. In embodiments, the content of sulfur (S) is within the range of from 0.3 to 0.99, e.g., within the range of from 0.5 to 0.95.

The molar fraction of said one or more elements; iron (Fe), tungsten (W), cobalt (Co), vanadium (V) and ruthenium (Ru), in said amorphous and unsupported sulfided molybdenum catalyst with respect to the molar fraction of molybdenum (Mo) may be within the range of from 0.1 to 0.3, optionally within the range of from 0.1 to 0.2.

An important advantage with the catalyst being an unsupported carrier-free catalyst is that it can be added at different stages of the process, for example after the starting material is ground, and thus be intimately mixed with the starting material.

Preferably said catalyst is introduced into the mixture of lignocellulosic starting materials in the form of a slurry of catalyst particles in a liquid co-feed, optionally a pure liquid or a mixture of different liquid components. The liquid co-feed may be a hydrocarbon co-feed.

The co-feed may be chosen from vegetable oils and fats, such tall oil and tall oil pitch, pyrolysis oil, HTL oil, animal fats, fatty acids, fossil or renewable liquid hydrocarbons, and/or a re-circulated or recycled product or a fraction of the product obtained in said process.

In exemplary embodiments, the co-feed is a mixture of a vegetable oil, and/or animal fats, and a fossil or renewable hydrocarbon.

The total feed may consist of from 5 to 90% by weight of solid biomass, preferably within the range of from 10 to 80% by weight of solid biomass. The total feed may consist of from 60 to 80% by weight of solid biomass or alternatively within the range of from 10 to 35% by weight of solid biomass. This implies that there is a liquid content of from 10% by weight, preferably up to 65% by weight, which may provide process advantages, such as a pumpable slurry.

The lignocellulosic starting material may have a dry content of more than 50% by weight, preferably within the range of from 70 and 95% by weight, most preferably within the range of from 80 to 92% by weight.

The lignocellulosic starting material may be chosen from wood chips and/or saw dust; forestry residue chosen from bark, and/or roots; wood having been subjected to drying or a torrefaction process; lignocellulose from agriculture like for example straw from crops like oats, wheat, barley and rye, corn stover, grasses and herbs, forage crops, oat husks, rice husks, construction waste containing at least 50% by weight originating from lignocellulosic matter; and mixtures thereof.

According to another embodiment, also freely combinable with the above aspect and embodiments, the lignocellulosic starting material has not been subjected to thermochemical treatment, such as pyrolysis or hydrothermal liquefaction, prior to being subjected to said process. Accordingly, a more simplified process can be achieved.

The organic liquefaction product may have a lower oxygen content than the feed, including the co-feed, optionally the organic liquefaction product may have at least 5% by weight lower oxygen content than the feed, including the co-feed, such as at least 10% by weight lower than the lignocellulosic starting material. The feed here including all the starting materials.

According to yet another embodiment, also freely combinable with the above aspect and embodiments, the operating pressure is within the range of from 50-300 bar. This may improve and accelerate the liquefaction process carried out at the temperature range of the present process.

The operating pressure may optionally be within the range of from 60-300 bar.

The mixture may be subjected to a temperature within the range of from 300° C. to 380° C. An operating temperature within this preferred range provides an improved liquid yield.

The process may or may not be split into two or more hydroprocessing reactors having a flat or increasing temperature profile. The process may thus include at least second converting step, subsequent to the first hydroprocessing step.

In the second hydroprocessing reactor, the operating temperature may be with the range of from 270-450° C., optionally the operating temperature in the second hydroprocessing reactor may be 350° C. or higher, such as within the range from 350° C. and 450° C.

In a preferred embodiment the hydroprocessing is carried out in two or more reactors in a series, in which each subsequent reactor is operated at a higher temperature than the first reactor. Preferably the process is carried out with three reactors in a series, and the temperature of the first reactor is selected from the range 270-350° C., the temperature of the second reactor is selected from the range 340-400° C., and the temperature of the third reactor is selected from the range 380-400° C.

A second aspect of the present disclosure relates to a molybdenum sulfide catalyst comprising one or more of the following elements (E); iron (Fe), tungsten (W), cobalt (Co), vanadium (V) and ruthenium (Ru), characterized in that said catalyst has the empirical formula with regard to molybdenum (Mo), said one or more element(s) (E) and sulfur (S):

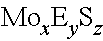

wherein x=1, 0.1<y<0.3 and z≤2.3.

An important advantage with the inventive catalyst is that it is relatively cheap and easy to manufacture. Further, as it can be used as such, without being bound to a carrier, it can be added at different stages of the process.

For example, the molar fraction of sulfur (S) in the amorphous and unsupported sulfided molybdenum catalyst with respect to the molar fraction of molybdenum (Mo) is within the range of from 0.1 to 2.3. The molar fraction of sulfur (S) in the amorphous and unsupported sulfided molybdenum catalyst with respect to the molar fraction of molybdenum (Mo) may be ≤1.0, optionally within the range of from 0.1 to 1.0. In embodiments, the content of sulfur (S) is within the range of from 0.3 to 0.99, e.g. within the range of from 0.5 to 0.95.

The molar fraction of said one or more elements; iron (Fe), tungsten (W), cobalt (Co), vanadium (V) and ruthenium (Ru), in said amorphous and unsupported sulfided molybdenum catalyst with respect to the molar fraction of molybdenum (Mo) may be within the range of from 0.1 to 0.3, optionally within the range of from 0.1 to 0.2.

Preferably said catalyst is substantially amorphous as determined by X-ray powder diffraction analysis and optical microscopy using polarized light. Optionally, the catalyst is amorphous, as determined by X-ray powder diffraction analysis.

According to an embodiment of said second aspect, said catalyst has a particle size distribution with a median value within the range of from 1 to 500 μm as determined by laser diffraction. Preferably, the catalyst has a particle size distribution with a median value within the range of from 1 to 200 μm as determined by laser diffraction. An advantage of such particle size distribution is an improved dispersion in the feed slurry and that the catalyst is available in the whole reactor volume, compared to supported or larger catalyst particles which are only available in the reaction zone. It furthermore renders the catalyst accessible for larger molecules and provides an increased activity.

A third aspect of the present disclosure relates to a process for the conversion of lignocellulosic starting materials into an organic liquefaction product, characterized in that a mixture of lignocellulosic starting materials, a catalyst according to the second aspect and embodiments thereof, and a co-feed, is subjected to not less than a stoichiometric amount of hydrogen, elevated pressure and a temperature in the interval within the range of from 270° C. to 450° C., producing an organic liquefaction product.

A fourth aspect relates to a process of producing a molybdenum sulfide catalyst comprising one or more of the following elements (E); iron (Fe), tungsten (W), cobalt (Co), vanadium (V) and ruthenium (Ru), the process comprising the steps of
forming a first reaction mixture by mixing MoO₃, (NH₄)₂S, and water;
pressurizing said first mixture using hydrogen gas, heating and stirring the mixture;
forming a second mixture by adding, to the first mixture, a hydrocarbon fraction having a kinematic viscosity of less than 2.0 CSt @40° C. and a metal salt of Fe and/or W and/or Co and/or V and/or Ru, e g sulfate and/or nitrate salts of Fe, W, Co, V and Ru at a suitable pressure and temperature;
pressurizing said second mixture with hydrogen gas and heating it using a suitable temperature ramp;
depressurizing said second mixture and heating the residual hydrocarbon to a suitable temperature to remove water and part of the hydrocarbon fraction; and
recovering the catalyst in the form of a slurry with residual hydrocarbon.

In the step of forming the second mixture, the one or more of the following elements (E); iron (Fe), tungsten (W), cobalt (Co), vanadium (V) and ruthenium (Ru) may be added in amounts providing a catalyst has the empirical formula with regard to molybdenum (Mo), said one or more element(s) (E) and sulfur (S):

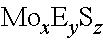

wherein x=1, 0.1<y<0.2 and z≤2.3

For example, the molar fraction of sulfur (S) in the amorphous and unsupported sulfided molybdenum catalyst with respect to the molar fraction of molybdenum (Mo) is within the range of from 0.1 to 2.3. The molar fraction of sulfur (S) in the amorphous and unsupported sulfided molybdenum catalyst with respect to the molar fraction of molybdenum (Mo) may be within the range of from 0.1 to 1.0. In embodiments, the content of sulfur (S) is within the range of from 0.3 to 0.99, e.g. within the range of from 0.5 to 0.95.

The molar fraction of said one or more elements; iron (Fe), tungsten (W), cobalt (Co), vanadium (V) and ruthenium (Ru), in said amorphous and unsupported sulfided molybdenum catalyst with respect to the molar fraction of molybdenum (Mo) may be within the range of from 0.1 to 0.3, optionally within the range of from 0.1 to 0.2.

The fact that the hydrocarbon fraction has a kinematic viscosity of less than 2.0 CSt @40° C. facilitates removal, by boiling, of water and separation by distillation to obtain a catalyst free from water, or at least substantially free from water.

Further aspects and embodiments will become apparent to a person skilled in the art upon study of the figures and the following detailed description and examples.

### SHORT DESCRIPTION OF THE DRAWINGS

The aspects and embodiments will now be described, by way of example, with reference to the accompanying drawings, in which:

FIG. 1 shows an XRPD-diffractogram for the catalyst according to Example 1.

FIG. 2 shows the particle size distribution for the catalyst according to Example 1.

FIG. 3 shows the TGA-data for the organic liquid product phase of Example 2.

FIG. 4 shows TGA-data for the THF-soluble liquefaction phase of Example 2.

FIG. 5 shows TGA-data for the organic liquid product phase of Example 4.

FIG. 6 shows TGA-data for the THF-soluble liquefaction phase of Example 4.

### DETAILED DESCRIPTION

When studying the detailed description, it is to be understood that the terminology employed herein is used for the purpose of describing particular embodiments only and is not intended to be limiting, since the scope of the present aspects and embodiments will be limited only by the appended claims and equivalents thereof.

It should be noted that, as used in this specification and the appended claims, the singular forms “a,” “an,” and “the” include plural referents unless the context clearly dictates otherwise.

The terms “lignocellulosic materials”, “lignocellulosic starting materials” and “lignocellulosic feed” are used herein to encompass all whole and non-fractionated lignocellulosic materials consisting substantially of cellulose, hemicellulose and lignin. Depending on geographic location, different materials are available, for example agricultural residues (e g corn stover, crop straw and bagasse), herbaceous crops (e g alfalfa, switchgrass), softwood and hardwood, short rotation woody crops, preheated and/or torrefied wood, forestry residues (bark as well as branches, roots and tops), and other waste (e g municipal and industrial waste containing whole lignocellulosic biomass like for example waste wood used in the construction industries and/or in packaging of goods). The present inventor has tested sawdust of pine having various dry substance contents, ground roots and branches of spruce, fresh spruce needles, fresh pine bark, and ground municipal waste containing wood, plastic, sand, metal and paint residues.

The terms “unsupported” and “carrier-free” are used to define that the catalyst material, for example the sulfided Mo catalyst is not deposited on any solid carrier or support material.

The fact that the catalyst is “amorphous” intends to mean that it is substantially amorphous, or amorphous, as determined by X-ray powder diffraction analysis.

The distinction between amorphous and crystalline material, as determined by X-ray powder diffraction analysis, is that crystalline materials will give sharp peaks in the XRD pattern while amorphous material will not give rise to any sharp peaks. Hence, an amorphous catalyst, as determined by X-ray powder diffraction analysis, will not give rise to any sharp peaks in the XRD pattern.

The terms “hydrocarbon fraction” and “hydrocarbon phase” relate here to a liquid hydrocarbon fraction recoverable at room temperature following the process disclosed herein, but the definition does not exclude that additional, more volatile hydrocarbons could be condensed at lower temperatures and included in this fraction.

The organic liquefaction product obtained may be liquid from room temperature, and up to 500° C. The organic liquefaction product may comprise one or more organic liquid phases.

The term “solid residue” here refers to remaining solids which is separated from the organic liquefaction products after hydroliquefaction of lignocellulose as exemplified in the experimental examples below. According to a first aspect, this process for the conversion of lignocellulosic starting materials into an organic liquefaction product is characterized in that a lignocellulosic starting material, either from a single source or from a mixture of relevant starting materials, an amorphous and unsupported sulfided molybdenum catalyst comprising one or more of the following elements (E); iron (Fe), tungsten (W), cobalt (Co), vanadium (V) and ruthenium (Ru), and optionally a co-feed, is mixed and subjected to not less than a stoichiometric amount of hydrogen, elevated pressure and a temperature within the range of from 270 to 450° C., producing an organic liquefaction product.

Preferably the catalyst according to the present disclosure is an amorphous and unsupported sulfided cobalt-molybdenum catalyst.

Preferably said catalyst is introduced into the mixture of lignocellulosic starting materials in the form of a slurry of catalyst particles in a hydrocarbon co-feed.

A co-feed is present in the process and the co-feed may be chosen from vegetable oils and fats, such as tall oil, tall oil pitch, pyrolysis oil, HTL oil, animal fats, fatty acids, fossil or renewable liquid hydrocarbons, and/or a re-circulated or recycled product or a fraction of the product obtained in said process.

The lignocellulosic starting material may have a dry content of more than 50% by weight, preferably within the range of from 70 and 95% by weight, most preferably within the range of from 80 to 92% by weight.

The lignocellulosic starting material may be chosen from wood chips and/or saw dust; forestry residue chosen from bark, and/or roots; wood having been subjected to drying or a torrefaction process; lignocellulose from agriculture like for example straw from crops like oats, wheat, barley and rye, corn stover, grasses and herbs, forage crops, oat husks, rice husks, construction waste containing at least 50% by weight originating from lignocellulosic matter; and mixtures thereof.

Regarding material that has been subjected to drying or a torrefaction process, it is underlined that torrefaction is here considered to be merely a drying step, i.e. the removal of moisture, and not a proper thermochemical process.

According to another embodiment, also freely combinable with the above aspect and embodiments, the lignocellulosic starting material has not been subjected to thermochemical treatment, such as pyrolysis or hydrothermal liquefaction, prior to being subjected to said process.

According to yet another embodiment, also freely combinable with the above aspect and embodiments, the operating pressure is within the range of from 50 to 300 bar, e.g. within the range of from 60 to 300 bar. When the process is operated in a batch-wise fashion, the initial pressure is set according to the available headspace volume and in a way which secures a stoichiometric excess of hydrogen, for instance set at an initial pressure at ambient temperature of 120 bar and allowed to increase and stabilize at within the range of from 150 to 300 bar, preferably 250 bar. When the process is operated in a continuous fashion, the pressure is preferably set at 70-180 bar, most preferably within the range of from 90 to 160 bar.

The mixture may be subjected to a temperature within the range of from 300° C. to 380° C. An operating temperature within this preferred range provides an improved liquid yield.

A second aspect of the present disclosure relates to a molybdenum sulfide catalyst comprising one or more of the following elements (E); iron (Fe), tungsten (W), cobalt (Co), vanadium (V) and ruthenium (Ru), characterized in that said catalyst has the empirical formula with regard to molybdenum (Mo), said one or more element(s) (E) and sulfur (S):

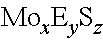

wherein x=1, 0.1<y<0.3 and z≤2.3.

Preferably said catalyst is substantially amorphous as determined by X-ray powder diffraction analysis. Optionally, the catalyst is amorphous, as determined by X-ray powder diffraction analysis.

Preferably the catalyst according to the present disclosure is an amorphous and unsupported sulfided cobalt-molybdenum catalyst.

According to an embodiment of said second aspect, said catalyst has a particle size distribution with a median value within the range of from 1 to 500 μm as determined by laser diffraction. Optionally, said catalyst has a particle size distribution with a median value within the range of from 1 to 200 μm as determined by laser diffraction

A third aspect of the present disclosure relates to a process for the conversion of lignocellulosic starting materials into an aqueous phase and a hydrocarbon phase, characterized in that a mixture of lignocellulosic starting materials, a catalyst according to the second aspect and embodiments thereof, and a co-feed, is subjected to not less than a stoichiometric amount of hydrogen, elevated pressure and a temperature within the range of from 270 to 450° C., producing one or more liquid phases and/or an aqueous phase and a hydrocarbon phase.

A fourth aspect relates to a process of producing a catalyst according to the second aspect and embodiments thereof, comprising the steps of
forming a first reaction mixture by mixing MoO₃, (NH₄)₂S, and water;
pressurizing said first mixture using hydrogen gas, heating and stirring the mixture;
forming a second mixture by adding, to the first mixture, a hydrocarbon fraction having a kinematic viscosity of less than 2.0 CSt @40° C. and a metal salt of Fe and/or W and/or Co and/or V and/or Ru, e g sulfate and/or nitrate salts of Fe, W, Co, V and Ru at a suitable pressure and temperature;
pressurizing said second mixture with hydrogen gas and heating it using a suitable temperature ramp;
depressurizing said second mixture and heating the residual hydrocarbon to a suitable temperature to remove water and part of the hydrocarbon fraction; and
recovering the catalyst in the form of a slurry with residual hydrocarbon.

The lignocellulosic start starting material is optionally subjected to mechanical pretreatment in order to simplify the material handling and to increase the surface to volume ratio. Suitable pretreatment operations include milling, chipping and grinding. In the experiments performed by the inventor so far, starting material of various particle sizes have been tested, for example 10 mm or smaller, such as within the range of from 0.5 mm to 10 mm, preferably the particle sizes of the lignocellulosic starting material is 2 mm or smaller. The results indicate that the process is capable of handling all these particle sizes, and that the particle size does not appear to be a critical factor.

In the step of forming the second mixture, the metal salt of Fe and/or W and/or Co and/or V and/or Ru, e g sulfate and/or nitrate salts of Fe, W, Co, V and Ru may be added in amounts providing a catalyst having the empirical formula with regard to molybdenum (Mo), said one or more element(s) (E) and sulfur (S):

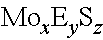

wherein x=1, 0.1<y<0.3 and z≤2.3.

When developing this disclosure, the inventor constructed a lab-scale batch process as described in closer detail in the examples. The batch process made it possible to test different lignocellulosic starting materials, compare the novel catalyst with other already known catalysts, and to test different process parameters. The process was also verified in semi-batch mode.

### EXAMPLES

### Analytical Methods

Determination of hydroxyl numbers analyzing amounts of hydroxyl groups belonging to aliphatic alcohols (aliphatic OH), phenols (aromatic OH) and OH-groups of carboxylic acids, was performed by ³¹P-NMR on a Bruker Avance 500 UltraShield NMR spectrometer using methodology described for instance in L. Akim et al. Holzforschung 2001, 55, 386-390. ¹H-NMR was used to characterize relative amounts of protons being part of aromatic, aliphatic, ether/alcohol, aldehyde, ketone, carboxylic acid and olefin functionalities of the obtained product mixtures.

Boiling point ranges were determined using thermogravimetric analysis on a Mettler-Toledo TGA/SDTA851e instrument.

Particle size distribution was performed using a Malvern Mastersizer 2000 laser diffractor.

X-ray powder diffraction analysis (XRPD) was performed on a PANalytical X'Pert PRO spectrometer.

### Example 1. Preparation of CoMo-Catalyst

Molybdenum trioxide (40 g), ammonium sulfide (60 mL, 20% w/w in water) and water (122 g) were added to a 1.8 L steel reactor. An inert nitrogen atmosphere was established using three vacuum—nitrogen cycles (nitrogen pressure 6 bar). The reactor was pressurized to 22 bar with hydrogen and the mixture was agitated using a pitch blade stirrer at 2.4 m/s tip speed. The jacket temperature was increased to 68° C. and after soaking for 4 hours the temperature was decreased to 38° C. The reactor was de-pressurized after which an inert atmosphere was established by using vacuum—nitrogen cycles (nitrogen pressure 6 bar). A mixture of n-dodecane (400 mL) and cobalt sulfate heptahydrate (45.9 g, 28.4 w/w % aqueous solution) was added to the reactor. The reactor was sealed, an inert nitrogen atmosphere was established using three vacuum—nitrogen cycles (nitrogen pressure 6 bar) before adding hydrogen to 25 bar pressure. The jacket temperature was increased to 210° C. during 6 hours. After an hour at that temperature the reactor content was allowed to cool to room temperature. The reactor was de-pressurized, after which an inert atmosphere was established by using vacuum—nitrogen cycles (nitrogen pressure 6 bar). After applying a condenser to the reactor, water and half the amount of the n-dodecane were distilled off at atmospheric pressure using a low flow of ballast nitrogen gas. After distillation the cooled reactor slurry content was removed from the reactor and sieved through a 280 μm stainless steel sieve with the catalyst protected from air, in order to remove larger particles. The catalyst is used and stored as a slurry in dodecane having an assay of 26.1% w/w based on triplicate measurements.

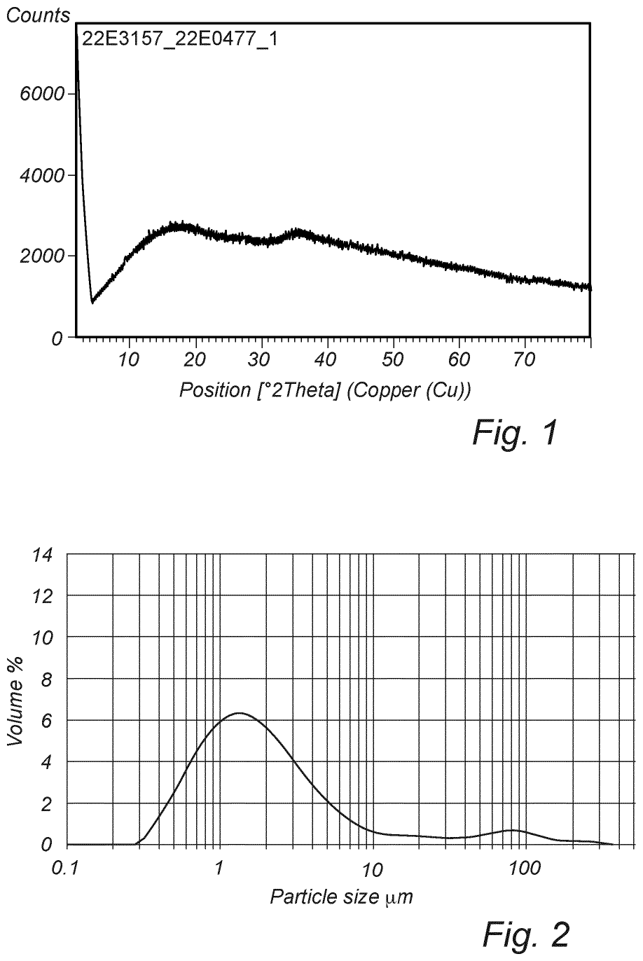

The XRPD-diffractogram for the catalyst according to Example 1 shown in FIG. 1 shows no XRPD peaks that would suggest any degree of crystallinity and the conclusion is that the catalyst according to Example 1 is amorphous.

FIG. 1 shows a XRPD-diffractogram for CoMoS-catalyst according to Example 1 showing that the catalyst is amorphous.

FIG. 2 shows the particle size distribution for CoMoS-catalyst according to Example 1. To determine the particle size distribution, an aliquot of the catalyst prepared according to Example 1 was dispersed in pure dodecane and analyzed by laser diffraction on a Malvern Mastersizer 2000 after in-situ ultra-sonication. The results indicate a median particle size of 1.6 μm.

### Example 2. Hydrodeoxygenation of Sawdust Using CoMo-Catalyst According to Example 1

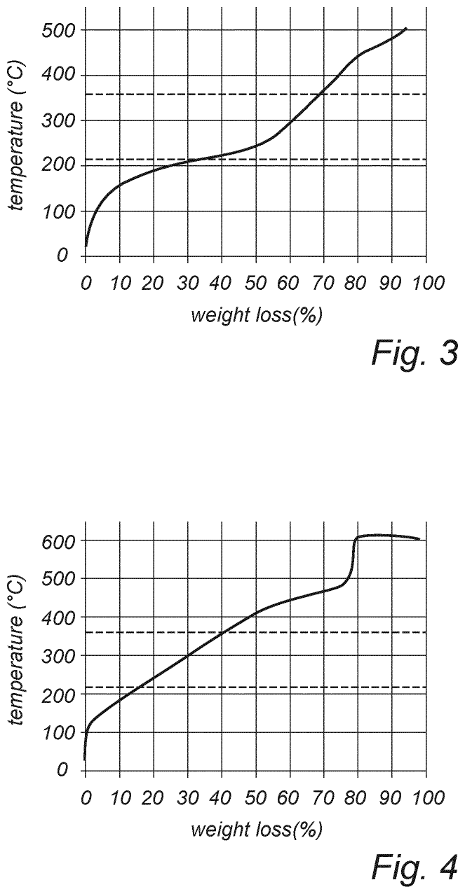

Milled and sieved pine sawdust (30.01 g, dry matter content 91.5% w/w), and a catalyst slurry prepared according to Example 1 (8.40 g, assay 26.1% w/w in dodecane) were added to a 300 mL stainless steel high-pressure reactor. An inert nitrogen atmosphere was established using three vacuum—nitrogen cycles before the reactor was pressurized with hydrogen (120 bar). The reactor contents were heated to 380° C. for two hours under stirring. After cooling, de-pressurization and establishment of an inert atmosphere by vacuum—nitrogen cycles, the reactor contents were poured into a centrifuge vial and centrifuged at 2.9×10-3 G for 20 minutes. An organic liquid phase, an aqueous phase, and a solid residue phase were separated. The solid residue, the reactor, lid and stirrer were washed consecutively using two portions of n-pentane (2×45 mL) and three 45 mL-portions of tetrahydrofuran (THF). After each wash the mixtures were centrifuged and separated. The n-pentane wash phases were pooled in one separate vessel and THF-wash phases were pooled in another separate vessel, after which solvents (n-pentane and THF) were evaporated. After complete work up, which for the pentane- and THF-phases included drying, the following products were isolated: an organic liquid phase which was pooled with the content of the n-pentane wash phase (16.46 g of a light amber liquid, 45% yield w/w calculated on the whole feed including dodecane), 8.45 g of an aqueous phase, 1.96 g of a THF-soluble liquefaction phase and 2.59 g of a solid residue. ¹H- and ³¹P-NMR-data for the organic liquid phase are found below (Tables 1 and 2) and TGA-data are shown in FIG. 3. ¹H- and ³¹P-NMR-data for the THF-soluble liquefaction phase are found below (Tables 3 and 4) and TGA-data are shown in FIG. 4. The NMR results indicate that the THF-soluble liquefaction phase has a higher oxygen content and this is confirmed by the elemental analysis data below. The amount of solid material isolated as calculated on dry biomass was only 1.4% w/w. Taking into account that the sawdust ash content was 0.6%, the amount of solid product is low.

Elemental analysis data for the organic liquid phase: C, 84.1%, H, 11.8%, N, 0.34%, S, 0.0%, O, 3.1%, other 0.48%.

Elemental analysis data for the THF-soluble liquefaction phase: C, 81.9%, H, 8.6%, N, 0.56%, S, 0.14%, O, 8.32%, other 0.48%.

Table 1 shows the ¹H-NMR (CDCl₃) results for the organic liquid phase of Example 2 (normalized integrals).

| Example 2: ¹H-NMR signals | ppm | Integral |
|---|---|---|
| Carboxylic acid H (COOH) and | 12-9 | 0 |
| aldehyde H (CHO) | | |
| Aromatic H | 9-6.2 | 6.1 |
| Olefin H | 6.2-4.5 | 0.1 |
| Aliphatic alcohol H, —CHOH or | 4.5-3.3 | 0.4 |
| aliphatic ether —CHOR | | |
| Aliphatic H | 3.3-0 | 93.4 |

Table 2 shows Hydroxyl numbers measured by ³¹P-NMR for the organic liquid phase of Example 2.

| | Aliphatic | Aromatic | |
|---|---|---|---|
| | OH | OH | Carboxylic |
| | (mmol/g) | (mmol/g) | acid |
| Example 2 | 0.14 | 1.24 | 0.004 |

FIG. 3 illustrates TGA-data for the organic liquid product phase of Example 2, the dotted lines indicate boiling point range of diesel.

Table 3 shows ¹H-NMR (DMSO-d6) results for Example 2, THF soluble liquefaction phase (normalized integrals).

| Example 2. ¹H-NMR signals | ppm | Integral |
|---|---|---|
| Carboxylic acid H (COOH) and | 12-9 | 2.0 |
| aldehyde H (CHO) and phenol (OH) | | |
| Aromatic H | 9-6.2 | 14.6 |
| Olefin H | 6.2-4.5 | 1.0 |
| Aliphatic alcohol H, —CHOH or | 4.5-3.3 | 5.1 |
| aliphatic ether —CHOR | | |
| Aliphatic H | 3.3-0 | 77.3 |

Table 4 shows Hydroxyl numbers measured by ³¹P-NMR for the THF-soluble liquefaction phase of Example 2.

| | Aliphatic | Aromatic | |
|---|---|---|---|
| | OH | OH | Carboxylic |
| | (mmol/g) | (mmol/g) | acid |
| Example 2 | 0.29 | 2.11 | 0.06 |

FIG. 4 illustrates TGA-data for the THF-soluble liquefaction phase of Example 2, wherein the dotted lines indicate boiling point range of diesel.

### Example 3. Preparation of CoMo-Catalyst—Second Example

The catalyst slurry from Example 1 (23.24 g, 47 mmol) was added to a 300 mL Buchi batch autoclave followed by the addition of DMDS (6.7 mL, 76 mmol). The reactor was sealed, inerted three times using N₂ (5 bar) and then pressurized to 80 bar using H₂. The reaction mixture was stirred at 800 rpm, heated to 300° C. during a heating ramp lasting for 1 h and was then left at this temperature for 12 h. After cooling, the headspace was bubbled into a beaker containing aqueous NaOH (30% w/w) to capture any H₂S in the headspace gas mixture. The NaOH-solution was then quenched with H₂O₂ to oxidize the sulfide to sulfate. The black slurry mixture inside the reactor was transferred to a vial. The reactor and stirrer were rinsed with 20 mL dodecane. The slurry dry catalyst assay was determined based on three individual samples arriving at 14.11% w/w.

### Example 4 Hydrodeoxygenation of Sawdust Using CoMo-Catalyst According to Example 3

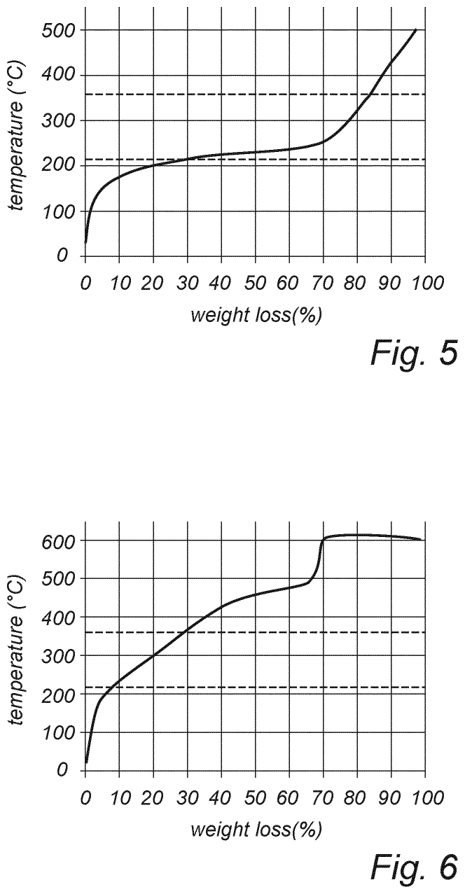

Saw dust having a particle size distribution<0.28 mm (30.0 g, dry matter content 91.5% w/w) and a catalyst slurry prepared according to Example 3 (10.12 g, assay adjusted from 14.11% w/w to 28.03% w/w in dodecane before use by centrifugation and removal of parts of the dodecane using a pipette, dry catalyst weight 2.84 g) were mixed at room temperature in a high-pressure reactor. An inert nitrogen atmosphere was established using vacuum—nitrogen cycles before the reactor was pressurized with hydrogen (116 bar). The reaction mixture was heated to 320° C. and kept at that temperature for 240 min. The maximum working pressure during reaction was 245 bars. After using the work up procedure described in Example 2, 11.39 g of a dark brown organic liquid phase (28% yield w/w calculated on the whole feed), 5.99 g of an aqueous phase, 6.68 g of a THF-soluble liquefaction phase (17% yield w/w calculated on the whole feed) and 3.17 g of a solid residue were isolated. ¹H- and ³¹P-NMR-data for the organic liquid phase is found below in Table, respectively and TGA-data are shown in FIG. 5. ¹H- and ³¹P-NMR-data for the THF-soluble liquefaction phase are found below in Table TGA-data are shown in FIG. 6. The NMR results indicate that the THF-soluble liquefaction phase has a higher oxygen content, something which is confirmed by the elemental analysis data below. The amount of solid material formed as calculated on dry biomass was, despite the low reaction temperature, only 1.2% w/w. Taking into account that the sawdust ash content was 0.6%, the amount of solid product is low.

Elemental analysis data for the organic liquid phase: C, 84.0%, H, 13.5%, N, 0.06%, S, 0.0%, O, 2.2%, other 0.31%.

Elemental analysis data for the THF-soluble liquefaction phase: C, 79.8%, H, 8.8%, N, 0.55%, S, 0.3%, O, 9.5%, other 1.07%.

Table 5 shows ¹H-NMR (CDCl₃) results for the organic liquid phase of Example 4 (normalized integrals).

| Example 4: ¹H-NMR signals | ppm | Integral |
|---|---|---|
| Carboxylic acid H (COOH) and | 12-9 | 0 |
| aldehyde H (CHO) | | |
| Aromatic H | 9-6.2 | 2.2 |
| Olefin H | 6.2-4.5 | 0.4 |
| Aliphatic alcohol H, —CHOH or | 4.5-3.3 | 0.03 |
| aliphatic ether —CHOR | | |
| Aliphatic H | 3.3-0 | 97.4 |

Table 6 shows Hydroxyl numbers measured by ³¹P-NMR for the organic liquid phase of Example 4.

| | Aliphatic | Aromatic | |
|---|---|---|---|
| | OH | OH | Carboxylic |
| | (mmol/g) | (mmol/g) | acid |
| Example 4 | 0.17 | 0.56 | 0.02 |

FIG. 5 illustrates TGA-data for the organic liquid product phase of Example 4, wherein the dotted lines indicate boiling point range of diesel.

Table 7 shows ¹H-NMR (DMSO-d6) results for Example 4, THF-soluble liquefaction phase (normalized integrals).

| Example 4: ¹H-NMR signals | ppm | Integral |
|---|---|---|
| Carboxylic acid H (COOH) and | 12-9 | 1.3 |
| aldehyde H (CHO) and phenol (OH) | | |
| Aromatic H | 9-6.2 | 12.4 |
| Olefin H | 6.2-4.5 | 0.03 |
| Aliphatic alcohol H, —CHOH or | 4.5-3.3 | 2.7 |
| aliphatic ether —CHOR | | |
| Aliphatic H | 3.3-0 | 83.6 |

Table 8 shows Hydroxyl numbers measured by ³¹P-NMR for the THF-soluble liquefaction phase of Example 4.

| | Aliphatic | Aromatic | |
|---|---|---|---|
| | OH | OH | Carboxylic |
| | (mmol/g) | (mmol/g) | acid |
| Example 4 | 0.3 | 2.9 | 0.1 |

FIG. 6 illustrates TGA-data for the THF-soluble liquefaction phase of Example 4, wherein the dotted lines indicate boiling point range of diesel.

1. A process for the conversion of lignocellulosic starting materials into an organic liquefaction product, characterized in that in a first hydroprocessing step a lignocellulosic starting material, an amorphous and unsupported sulfided molybdenum catalyst comprising one or more of the following elements; iron (Fe), tungsten (W), cobalt (Co), vanadium (V) and ruthenium (Ru), and a co-feed, are mixed, thereby obtaining a mixture, and said mixture is subjected to not less than a stoichiometric amount of hydrogen at an elevated pressure and a temperature within the range of from 270° C. to 450° C., thereby producing an organic liquefaction product.

2. The process according to claim 1, wherein the molar fraction of sulfur (S) in said amorphous and unsupported sulfided molybdenum catalyst with respect to the content of molybdenum (Mo) is within the range of from 0.1 to 2.3.

3. The process according to claim 1, wherein the molar fraction of said one or more elements; iron (Fe), tungsten (W), cobalt (Co), vanadium (V) and ruthenium (Ru), in said amorphous and unsupported sulfided molybdenum catalyst with respect to the molar fraction of molybdenum (Mo) is from 0.1 to 0.3.

4. The process according to claim 1, wherein the elevated pressure is a pressure within the range of from 50 to 300 bars.

5. The process according to claim 1, wherein said catalyst is introduced into said mixture of lignocellulosic starting materials in the form of a slurry of catalyst particles in a liquid co-feed.

6. The process according to claim 1, wherein said co-feed is chosen from vegetable oils and fats, such tall oil and tall oil pitch, pyrolysis oil, HTL oil, animal fats, fatty acids, fossil or renewable liquid hydrocarbons, and/or a re-circulated or recycled product or a fraction of the product obtained in said process.

7. The process according to claim 1, wherein said co-feed is a mixture of a vegetable oil and/or animal fats and a fossil and/or renewable hydrocarbon.

8. The process according to claim 1, wherein said lignocellulosic starting material has a dry content of more than 50% by weight.

9. The process according to claim 1, wherein said lignocellulosic starting material is chosen from wood chips and/or saw dust; forestry residue chosen from bark, and/or roots, and/or branches; wood having been subjected to drying or a torrefaction process; lignocellulose from agriculture like for example straw from crops like oats, wheat, barley and rye, corn stover, grasses and herbs, forage crops, oat husks, rice husks, construction waste containing at least 50% by weight originating from lignocellulosic matter; and mixtures thereof.

10. The process according to claim 1, wherein said lignocellulosic starting material has not been subjected to thermochemical treatment prior to being subjected to said process.

11. The process according to claim 1, wherein said process, subsequent to said first hydroprocessing step comprises at least a second converting step.

12. The process according to claim 1, wherein said mixture is subjected to a temperature within the range of from 300° C. to 380° C.

13. A molybdenum sulfide catalyst comprising one or more of the following elements (E); iron (Fe), tungsten (W), cobalt (Co), vanadium (V) and ruthenium (Ru), characterized in that said catalyst has the empirical formula with regard to molybdenum (Mo), said one or more element(s) (E) and sulfur (S):
$${Mo}_{x} {E}_{y} {S}_{z}$$
wherein x=1, 0.1<y<0.3 and z≤2.3.

14. The catalyst according to claim 13, wherein said catalyst is substantially amorphous, as determined by X-ray powder diffraction analysis and optical microscopy using polarized light.

15. The catalyst according to claim 13, wherein said catalyst has a particle size distribution with a median value within the range of from 1 to 500 μm as determined by laser diffraction.

16. The catalyst according to claim 13, wherein z≤1.0.

17. A process for the conversion of lignocellulosic starting materials into one or more liquid phases and/or an aqueous phase and a hydrocarbon phase, characterized in that a mixture of lignocellulosic starting materials, a catalyst according to claim 13, and a co-feed, is subjected to not less than a stoichiometric amount of hydrogen, an elevated pressure and a temperature within the range of from 270° C. to 450° C., thereby producing one or more liquid phases and/or an aqueous phase and a hydrocarbon phase.

18. A process of producing a molybdenum sulfide catalyst comprising one or more of the following elements (E); iron (Fe), tungsten (W), cobalt (Co), vanadium (V) and ruthenium (Ru), the process comprising the steps of
forming a first reaction mixture by mixing MoO₃, (NH₄)₂S, and water;
pressurizing said first mixture using hydrogen gas, heating and stirring the mixture;
forming a second mixture by adding a hydrocarbon fraction having a kinematic viscosity of less than 2.0 CSt @40° C. and a metal salt of Fe and/or W and/or Co and/or V and/or Ru at a suitable pressure and temperature,
pressurizing said second mixture with hydrogen gas and heating it using a suitable temperature ramp;
depressurizing said second mixture and heating the residual hydrocarbon to a suitable temperature to remove water and part of the hydrocarbon fraction; and
recovering the catalyst in the form of a slurry with residual hydrocarbon.

19. The process according to claim 18, wherein the step of forming a second mixture, the metal salt of Fe and/or W and/or Co and/or V and/or Ru is added in amounts providing a catalyst having the empirical formula with regard to molybdenum (Mo), said one or more element(s) (E) and sulfur (S):
$${Mo}_{x} {E}_{y} {S}_{z}$$
wherein x=1, 0.1<y<0.3 and z≤2.3.
